(19) United States
(12) Patent Application Publication
(10) Pub. No.: US 2003/0033201 A1
(43) Pub. Date: Feb. 13, 2003

(54) Data screening and compensation method

(76) Inventor: Olav M. Vangstad, Northridge, CA (US)

Correspondence Address: Olav M. Vangstad, 25014 Avenue Kearny, Valencia, CA, 91355, US

(21) Appl. No.: 10/213,211

(22) Filed: Aug. 6, 2002

Related U.S. Application Data
(60) Provisional application No. 60/311,669, filed on Aug. 13, 2001.

(51) Int. Cl. G06F 17/60

(52) U.S. Cl. 705/14

(57) ABSTRACT

Improved method for screening electronic data and means of providing compensation to recipients for scanning or reading unsolicited data

### RELATED CASES

This invention is described in my copending Provisional Application Ser. No. 60/311,669 filed Aug. 13, 2001 and now Aug. 6, 2002.

### FIELD OF INVENTION

This invention relates to electronic data discrimination methods permitting cash compensation to the recipient or to an alternate recipient for viewing electronic data.

### PRIOR ART

The Internet has become a dominant communication tool but this communication tool (e-mail) can be used for good or abused. The amount of unsolicited mail (Junk) received by the average e-mail user is very high. Junk requires time and attention to identify and delete, and it also obscures messages of importance. Unfortunately nothing has been done to overcome this problem and people are deprived of their time in filtering valuable email from “junk” email. No method has been offered to compensate email recipients for their time in scanning or reading such material and no method has been provided by advertisers to give incentives for recipients to read their material(s).

### BRIEF SUMMARY AND OBJECTS OF INVENTION

These disadvantages of the prior art are overcome with the present invention and improved data screening which allows e-mail advertisers to offer e-mail readers money, services or products for reading mail, and e-mail recipients to control what mail may be transmitted to their e-mail communications devices (computers). Alternatively, e-mail users may allow advertisers to transmit their messages providing the advertiser contributes to designer such as a charity specified by, or meets with the approval of, the e-mail user.

E-mail advertisers may contract directly with e-mail users to provide compensation for receipt of e-mail. Alternatively, advertisers may use third parties (Intermediaries) to transmit e-mail to willing readers and for accounting and administrative purposes. Intermediaries may perform services for many advertisers. Using their lists of e-mail recipients with whom they have agreed to provide compensation, Intermediaries transmit the advertisers' messages to all e-mail recipients whose stated receipt criteria are met by the advertisers.

Accordingly, it is an object of the present invention to provide improved data screening methodology and compensation to electronic data recipients.

Another object of the present invention is to provide email users with a tool whereby they can agree with advertisers or Intermediaries to receive mail for a stated monetary fee, service, goods or ‘points, miles or credits” for use in redemption of it. The fee specified by the e-mail recipient may be a fee applicable to all e-mail or varied by the subject of the e-mail.

A further object of the present invention is to provide a method whereby electronic transmissions are reduced. Electronic handling and storage of “junk” files are reduced and or eliminated. Usable Bandwidth is increased and the general public benefits from reduced data transmission and its corresponding overhead.

These and other objects and features of the present invention will be apparent from the following detailed description, taken with reference to the figures of the accompanying drawing.

### BRIEF DESCRIPTION OF THE DRAWING

FIG. 1 is a diagrammatic representation of the method whereby electronic data is screened and filtered embodying the present invention.

### DETAILED DESCRIPTION OF THE INVENTION

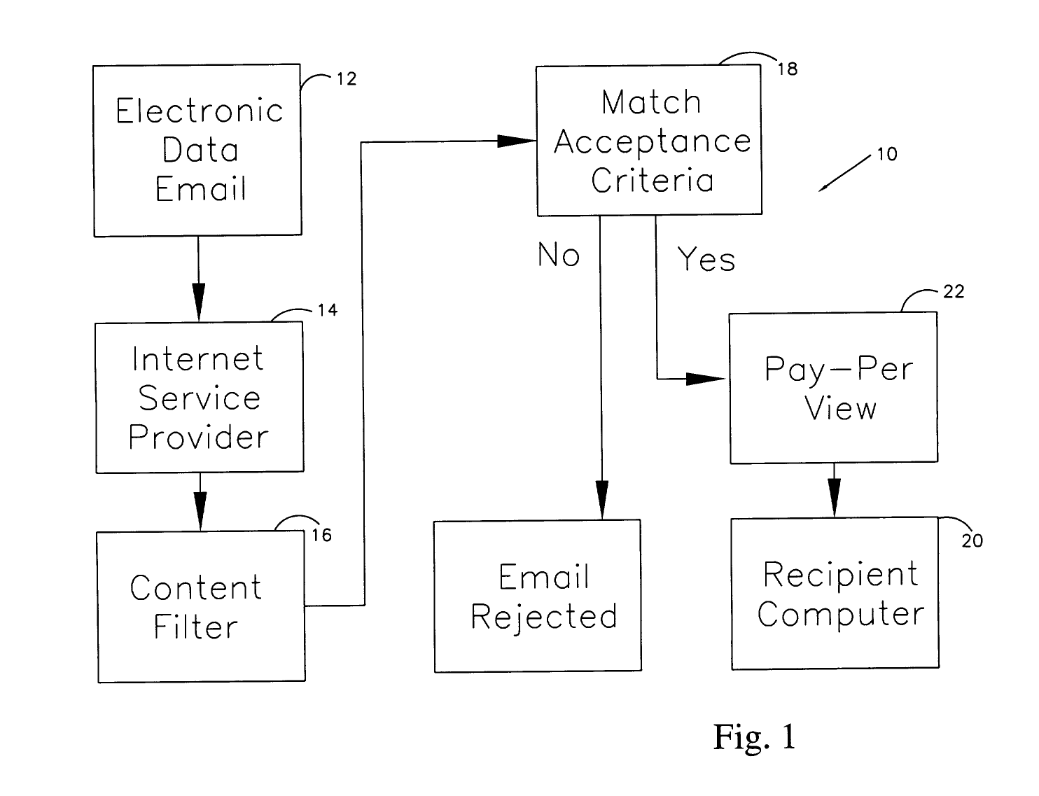

In that form of the present invention chosen for purposes of illustration, FIG. 1 shows a method whereby electronic data originates at a source 12 and is transmitted via an (ISP) Internet Service Provider 14 through a content filter 16 which may reside with the ISP or be resident on the recipients computer. When the data matches predetermined categories, compensation amounts or other filters 18 the data is permitted to flow to the recipients email 20 and upon the conditions for viewing compensation is made 22 to the recipient or designated party.

In use, an e-mail recipient who is interested in dogs may agree to receive all email on that subject for a reduced or no fee. It is anticipated that standardized subject categories, symbols and conventions will be developed to aid in the communications process and that e-mail recipients may access their files and change mail receipt parameters at any time.

An example of transactions follows. User, an e-mail user is tired of receiving Junk. User contracts (signs up) with Stopjunk, an intermediary, to stop all unsolicited mail unless User receives $0.10 per message. A large car company contracts with Stopjunk to distribute its advertisements to all e-mail recipients for a fee not to exceed $0.15 per delivered e-mail. Stopjunk works on a $0.04 minimum margin and distributes the mail to User and all who are willing to receive it for $0.11 or less. The large car company and other clients pay Stopjunk for messages delivered. Periodically, Stopjunk distributes money, miles, points or credits to its customers.

What is claimed is:

1. A method whereby a recipient of unsolicited electronic data may be compensated for reading or scanning such material.

2. The method of claim 1 wherein the discrimination of data, classification or filtering resides with the ISP

3. The method of claim 1 wherein the discrimination of data, classification or filtering resides with the recipient.

4. The method of claim 1 wherein the compensation to recipient may be filtered to allow various levels of compensation per category, subject matter or time of delivery.

5: The method of claim 1 wherein the use of an Intermediary or service may manage, control and establish standards for compensation and bulk handling of electronic data.
